(19) United States
(12) Patent Application Publication
(10) Pub. No.: US 2007/0148380 A1
(43) Pub. Date: Jun. 28, 2007

(54) Paintball and method of manufacture

(75) Inventor: Christopher Black, Lasalle (CA)

Correspondence Address: Mila Shvartsman, P.O. Box 48652, Outremont, QC, H2V 4T9, CA

(73) Assignee: Procaps L.P.

(21) Appl. No.: 11/640,944

(22) Filed: Dec. 19, 2006

Related U.S. Application Data
(60) Provisional application No. 60/753,416, filed on Dec. 27, 2005.

(51) Int. Cl. B31B 45/00

(52) U.S. Cl. 428/34.1

(57) ABSTRACT

The present invention relates to a paintball comprising a shell containing an inner filler composition. The shell comprises a mixture of gelatin and mineral oil; the inner filler composition comprises a mixture of starch, oil, an emulsifying agent and a spreading and surfacting agent. The shell further comprises a non-crystallizing polyhydric alcohol, glycerine, and water. The inner filler composition may further comprise a pigment. The non-crystallizing polyhydric alcohol may be sorbitol, the oil is Soya oil and the emulsifying agent is emulsifying wax. The spreading and surfacting agent may be Tween® 20 and the pigment may be TiO₂.

This application is based on the Provisional patent application No. U.S. 60/753,416. The present invention relates to paintballs, and more particularly to a new and improved shell and paintball filler composition and method of manufacture.

For years, the paintball industry's standard ingredient for paintball filler has been polyethylene glycol as the base for all ingredients, such as shown in U.S. Pat. No. 5,393,054 to Rouffer issued Feb. 28, 1995. There are several grades of polyethylene glycol used for filler, but most common are polyethylene glycol 300 and 400.

Depending on formulae, the percentage of polyethylene glycol used in paintballs ranges from 75% to 95%. Additives that thicken the filler vary from manufacturer to manufacturer. Polyethylene glycol “PEG 3350”, starches, pigments, dyes and other ingredients have been added to enhance the thickness and marking ability of the filler. Glycerine, titanium and water are also used.

To produce a filler using these ingredients, it is necessary to first heat up the polyethylene glycol. After it reaches set temperature, polyethylene glycol PEG 3350 is added. When it dissolves to clear liquid, water, glycerine, blended dyes and titanium are added. Then the mixture must to be cooled down to become more viscous.

The primary disadvantage of these previously known paintballs is that they are costly due to use of polyethylene glycol. Attempts to use substitutes such as starches, oleic acid, and other cheaper ingredients have been unsuccessful due to the fragile balance between the paintball's shell and contents. Chemical incompatibilities caused the various fillers to dissolve the shell, rendering the paintball useless.

There is known U.S. Pat. No. 6,375,981 describing film-forming composition for capsules comprising a waxy starch, water, plasticizer and gum that may be used for production of soft gel for food, pharmaceutical and industrial applications. However, such composition may be not compatible with some fillers.

The present invention overcomes the above disadvantages; it relates to a new, less expensive paintball shell formula and a substantially cheaper filler formula.

### DETAILED DESCRIPTION OF THE PREFERRED EMBODIMENT

New Shell and Method of Manufacture

The main obstacle in producing a less-expensive filler is its instability with the conventional gelatin shell. Prior attempts to reduce the filler cost have yielded paintballs whose fill attacked the shell, resulting in complete paintball disintegration inside their packaging thus rendering themselves useless. Thus, it is of importance to the present invention that the gelatin shell be chemically stable with the filler.

In the preferred embodiment, the paintball shell comprises:
Gelatin (39.29%)
Sorbitol (4.34%)
Glycerine (6.89%)
Drakeol 7™ (8.16%)
Water (41.32%)

Sorbitol plays the role of humectant or rubberizing agent, and is related to a preferred non-crystallizing polyhydric alcohol. Other non-crystalline forms of sorbitol are “Sorbo” and “Sorbitol Special”, each of which is available from ICI Americas. Other useful non-crystallizing polyhydric alcohols include pentaerythritol, glycerol, propylene glycol, and low-molecular-weight polyethylene glycol.

Drakeol 7™ pays the role of barrier and is related to a commercial brand of white mineral oil. Examples of suitable, commercially available mineral oils include Sonneborn™ and Carnation™ white oils from Witco, Isopar™ K and Isopar™ H from Exxon, and Peneteck™ white mineral oils from Penreco.

Gelatin plays the role of a gel-forming agent and water is a diluting agent.

The method of preparation of the preferred embodiment of the gelatin shell used in the encapsulation of the present paintball is as follows:

water, glycerine, sorbitol, and Drakeol 7™ are added into the reactor. The mixture is heated to 162° F. and the gelatin is added to the mixture. The mixture is heated further to 172° F. and mixed for 20 minutes. After appropriate mixing, the gelatin is chilled to 143.5° F. and ready for use.

Method of Manufacture of Paintball Filler

1. One Phase Method:

The method of manufacture of paintball filler is the most important component of the present invention. Although a range of proportions and methods may be used (as described further), the preferred embodiments method comprises the following:

Starch (41.86%)

Soya Oil (52.23%)

Pigments (1.15%)

Tween® 20 (1.15%)

Emulsifying Wax (3.61%)

Starch acts as a thickening agent, and various possible types of starch may be corn starch, potato starch, rice starch, wheat and tapioca.

Soya oil acts as a carrier agent and is the preferred oil; one may substitute corn oil, canola, peanut oil, olive oil, palm oil, linseed oil, or any combination thereof.

Tween® 20, also known generically as Polysorbate 20, is a surfactant and spreading agent. Emulsifying wax acts as an emulsifying agent and is used as a binding agent between two usually non-compatible materials, in this case, the starch and oil. Both ingredients Tween® 20 and wax bind the materials but the emulsifying wax has the added property of keeping the heavier particles in suspension.

The procedure for making the filler begins with half the Soya oil being introduced into the reactor. The starch is mixed in at high speed; once the mixture has been thoroughly mixed for 30 minutes, the remaining Soya oil is slowly introduced. Once the mixture is homogenous, Tween® 20 is slowly mixed in at high speed for 60 minutes to be integrated into the mixture. The mixture is then heated to 55° C. and the emulsifying wax is added. The mixture is again thoroughly mixed for 30 minutes at high speed to be integrated. Further, the mixture is chilled to 27° C., and pigments are introduced at high speed and mixed for 10 minutes. Once the mixture is smooth, it is ready for use.

While the above formula illustrates the preferred embodiment, it is understood that many variations are possible using starch and oil. In experimentation, the following limits have been discovered to produce acceptable results:

Lower: 30% Starch to 65% Oil

Upper: 50% Starch to 45% Oil

5% pigments, Tween® 20, dye and wax

Two Phase Method:

The above describes the preferred embodiment of the present invention. However, a two-phase variation is also possible:

Phase 1:

The ingredients for this phase are as follows:
TiO₂ (14.29%)
Tween® 20 (81.57%)
Dye (4.14%)
   Tween® 20 and dye are thoroughly mixed at high speed and high shear and filtered to remove any solid mass. When the mixture is completely clear pigment agent, such as TiO₂ is then slowly added in an emulsification procedure and mixed for an additional 10 minutes.
   Phase 2:

The ingredients for phase 2 are as follows:
Starch (53.50%)
HPFU (a blend of oils) (37.50%)
TiO₂ (1.00%)
Phase 1 mixture (3.00%)
Emulsifying Wax (3.87%)
   While ingredients of Phase 1 are mixing Phase 2 is in process:

HPFU is poured into the reactor and starch is slowly added while mixing at high speed with HPFU in the reactor for 60 minutes. TiO₂ is added slowly into the mixture and mixed for 10 minutes to facilitate complete blending of all ingredients. Further, all ingredients of Phase 1 are added at high speed and mixed for another 60 minutes Then mixture is heated to 65° C. and emulsifying wax is thoroughly blended into the pre-warmed mixture for 30 minutes at highest speed. Mixture is cooled down until the product is at room temperature and is ready for encapsulation.

Non-limiting examples of suitable oleaginous liquids include mineral oils; natural oils such as castor oil, cottonseed oil, olive oil, almond oil, peanut oil, rapeseed oil, corn oil, sesame oil, safflower oil, hemp oil, linseed oil, tung oil, oiticica oil, jojoba oil, meadowfoam oil, and the like. Other suitable oleaginous liquids may include synthetic oils such as homo- and inter-polymers of C2-C12 olefins, carboxylic acid esters of both monoalcohols and polyols, polyethers, silcones, polyglycols, silicates, alkylated aromatics, carbonates, thiocarbonates, orthoformates, phosphates and phosphites, borates and halogenated hydrocarbons. Representative of such oils or homo- and interpolymers of C2-C12 monoolefinic hydrocarbons, alkylated benzenes (e.g., dodecyl benzenes, didodecyl benzenes, tetradecyl, benzenes, dinonyl benzenes, di-(2-ethylhexyl-)benzenes, wax-alkylated naphthalenes); and polyphenyls (e.g., biphenyls, terphenyls). Alkylene oxide polymers and interpolymers and derivatives thereof where the terminal hydroxyl groups have been modified by esterification, etherfication, etc., constitute another class of synthetic oils.

Preferably, but not necessary paintballs of the present invention are manufactured by means of an encapsulating method which is known in the art.

There are some drawbacks to the above paintball, such as:
reduced surface area of the resulting paintball hit because the filler of the present invention is thicker in consistency than the prior art paintballs;
the use of the paintballs of the present invention is limited mostly for cold or cool weather since the filler starts to deteriorate when temperature is above 25° C.

Thus, it can be seen that the objects of the present invention have been satisfied by the structure presented hereinabove. While in accordance with the Patent Statutes, only the best mode and preferred embodiments of the present invention have been presented and described in detail, it is to be understood that the invention is not limited thereto or thereby.

1. Paintball comprising:
a shell containing
an inner filler composition;
wherein said shell comprises a mixture of
a gelatin and
a mineral oil; and
wherein said inner filler composition comprises a mixture of
a starch
an oil
an emulsifying agent and
a spreading and surfacting agent.

2. Paintball according to claim 1, wherein said shell further comprises a non-crystallizing polyhydric alcohol.

3. Paintball according to claim 2, wherein said shell further comprises glycerine.

4. Paintball according to claim 3, wherein said shell further comprises water.

5. Paintball according to claim 1, wherein said inner filler composition further comprises a pigment.

6. Paintball according to claim 2, wherein said non-crystallizing polyhydric alcohol is sorbitol.

7. Paintball according to claim 1, wherein said oil is Soya oil.

8. Paintball according to claim 1, wherein said emulsifying agent is emulsifying wax.

9. Paintball according to claim 1, wherein said spreading and surfacting agent is Tween® 20

10. Paintball according to claim 5, wherein said pigment is TiO₂.

11. Paintball according to claim 1, wherein the proportion of said starch and oil in said inner filler composition is from 30% starch and 65% oil at the lower level to 50% starch and 45% oil in the upper level, and wherein said emulsifying agent and said spreading and surfacting agent contain the remaining 5% of the total mixture.

12. Paintball according to claim 4, wherein said shell contains 39.29% gelatin, 4.34% non-crystallizing polyhydric alcohol, 6.89% glycerine, 8.16% oil and 41.33% water.

13. A method of manufacturing a paintball comprising:
manufacturing an outer shell comprising the following steps:
heating an oil to a predetermined temperature;
adding a gelatin to said heated oil,
mixing said gelatin with said oil;
continuous heating of mixture of said gelatin and said oil under predetermined temperature for a predetermined time;
chilling said mixture;
forming said outer shell;
and wherein manufacturing of said inner filler comprising the following steps:
mixing an oil and a starch in a reactor;
adding a spreading and surfacting agent to a mixture of said oil and starch;
mixing said spreading and surfacting agent with said mixture;
heating said mixture to a predetermined temperature;
adding an emulsifying agent to said mixture;
thoroughly mixing said mixture to facilitate a complete integration;
chilling said mixture and
filling said outer shell with said chilled mixture.

14. Method according to claim 13, wherein water, glycerine and sorbitol compositions are further introduced to said inner fill composition.

15. Method according to claim 14, wherein a pigment composition is further introduced to said inner filler composition.

16. Method according to claim 15, wherein said pigment composition is introduced after said mixture is chilled.

17. Method according to claim 15, wherein said pigment composition is preliminary mixed with said spreading and surfacting agent, and said mixed ingredients are introduced into the reactor before adding of said emulsifying agent.

18. Method according to claim 13, wherein said oil is mixed with said starch in said reactor in the following manner:
one half of said oil is preliminarily introduced into said reactor;
said oil is mixed with said starch at high speed to facilitate thorough mixing;
the remaining half of said oil is slowly introduced to facilitate homogenous mixing.

19. Paintball comprising:
a shell containing
an inner filler composition;
wherein said shell comprises a mixture of
a gel-forming agent and
a carrier agent; and
wherein said inner filler composition comprises a mixture of
a thickening agent
a volume displacement agent
an emulsifying agent and
a spreading and surfacting agent.

20. Paintball according to claim 19, wherein said shell further comprises a humectant rubberizing agent.

21. Paintball according to claim 20, wherein said humectant rubberizing agent is a non-crystallizing polyhydric alcohol.

22. Paintball according to claim 19, wherein said gel-forming agent is gelatin.

23. Paintball according to claim 19, wherein said shell further comprises a diluting agent.

24. Paintball according to claim 23, wherein said diluting agent is water.

25. Paintball according to claim 24, wherein said shell further comprises glycerine.

26. Paintball according to claim 19, wherein said thickening agent is a starch.

27. Paintball according to claim 19 wherein said inner filler composition is further comprising a pigment agent.

28. Paintball according to claim 21, wherein said non-crystallizing polyhydric alcohol is sorbitol.

29. Paintball according to claim 19, wherein said volume displacement agent is oil.

30. Paintball according to claim 29, wherein said oil is Soya oil.

31. Paintball according to claim 19, wherein said emulsifying agent is emulsifying wax.

32. Paintball according to claim 19, wherein said spreading and surfacting agent is Tween® 20

33. Paintball according to claim 27, wherein said pigment agent is TiO₂.

34. A method of manufacturing a paintball comprising:
manufacturing an outer shell comprising the following steps:
heating a carrier to a predetermined temperature;
adding a gel agent to said heated oil,
mixing said gel agent with said oil;
heating a mixture of said gel agent and said carrier under predetermined temperature for a predetermined time;
chilling said mixture;
forming said outer shell;
and wherein manufacturing of said inner filler comprises the following steps:
mixing a volume displacement and a thickening agent in a reactor;
adding a spreading and surfacting agent to a mixture of said oil and starch;
mixing said spreading and surfacting agent with said mixture;
heating said mixture to a predetermined temperature;
adding an emulsifying agent to said mixture;
thoroughly mixing said mixture to facilitate complete integration;
chilling said mixture and
filling said outer shell with said chilled mixture.

35. Method according to claim 34, wherein water, glycerine and sorbitol compositions are further added to said inner filler composition.

36. Method according to claim 34, wherein a pigment composition is further introduced to said inner filler composition.

37. Method according to claim 36, wherein said pigment composition is introduced after said mixture is chilled.

38. Method according to claim 36, wherein said pigment composition is preliminary mixed with said spreading and surfacting agent, and said mixed ingredients are introduced into the reactor before adding of said emulsifying agent.

39. Method according to claim 34, wherein said volume displacement agent is mixed with said thickening agent in said reactor in the following manner:
one half of said volume displacement agent is preliminarily introduced into said reactor;
said volume displacement agent is mixed with said thickening agent at high speed to facilitate thorough mixing;
the remaining half of said volume displacement is slowly introduced to facilitate homogenous mixing.
